(19) United States
(12) Patent Application Publication
(10) Pub. No.: US 2025/0070953 A1
(43) Pub. Date: Feb. 27, 2025

(54) SYSTEMS AND METHODS FOR FULL DUPLEX DOCSIS (FDX) AMPLIFIER AUTOMATIC CONFIGURATION

(71) Applicant: Comcast Cable Communications, LLC, Philadelphia, PA (US)

(72) Inventor: Richard PRODAN, Niwot, CO (US)

(21) Appl. No.: 18/814,101

(22) Filed: Aug. 23, 2024

Related U.S. Application Data
(60) Provisional application No. 63/578,898, filed on Aug. 25, 2023.

(51) Int. Cl. H04L 5/14

(52) U.S. Cl. CPC H04L 5/14

(57) ABSTRACT

A device may configure an FDX amplifier, wherein the device is a component of the FDX amplifier. The device may configure a gain and/or an equalization of a downstream signal. The device may determine a gain associated with the downstream signal traversing from a first port of the FDX amplifier to a second port of the FDX amplifier. The device may determine an equalization associated with the downstream signal at the second port of the FDX amplifier. The device may determine a gain associated with the upstream signal traversing from the second port of the FDX amplifier to the first port of the FDX amplifier. The device may determine an equalization associated with the upstream signal at the first port of the FDX amplifier.

### CROSS REFERENCE TO RELATED APPLICATIONS

This application claims the benefit of and is a non-provisional of U.S. Provisional Application No. 63/578,898, filed Aug. 25, 2023, which is hereby incorporated by reference in its entirety.

### BACKGROUND

Data over cable service interface specifications (DOCSIS) generally relates to standards enabling data transfer, for example data transfer via hybrid fiber-coaxial networks including coaxial cables installed in users' residences. DOCSIS describes that signals may cause data to be sent from and/or to a central location, for example between a server associated with an internet service provider and an end user, for example in a user's residence. The downstream signal may be transmitted from, for example, a node. An upstream signal may transmit data from a user to, for example, the same node. Typically, the downstream channel and the upstream channel occupy different frequency bands. For example, a downstream channel may occupy a higher frequency band than an upstream channel. However, it is desirable to provide a larger frequency band to both the downstream channel and the upstream channel. Thus, improvements are needed to allow for the downstream channel and the upstream channel to occupy larger frequency bands.

### SUMMARY

Systems, methods, and apparatuses are described herein for configuring amplifiers in a full duplex DOCSIS (FDX) scheme. FDX technology describes a system and method for sending downstream and upstream data on the same frequency band. Sharing bandwidth between downstream and upstream channels may provide for a larger frequency band for each channel. In particular, the upstream channel typically occupies a lower frequency band in a split DOCSIS scheme, so providing a larger frequency band to the upstream channel may provide significantly more bandwidth to the upstream channel. Using a same frequency band for both the downstream and upstream channels may cause much more interference for each channel than a system using split frequency bands. For example, the downstream signal may cause significant noise among an upstream signal as the downstream signal and upstream signal interact at particular apparatuses in the system, for example in amplifiers positioned along a series of cascading user devices. A system may determine an initial downstream signal input associated with an FDX amplifier, wherein a downstream signal traverses a configuration system within the FDX amplifier, and wherein the configuration system configures at least one of a gain and an equalization associated with the downstream signal. The system may determine, based on a path loss associated with the downstream signal traversing from a first port of the FDX amplifier to a first input of the configuration system, and further based on a span loss of the downstream signal traversing from an output port of a different amplifier to the first port of the FDX amplifier, an adjusted downstream signal input associated with the amplifier. The system may determine a path gain associated with the downstream signal traversing from a first output of the configuration system to a second port of the FDX amplifier. The system may determine an equalization associated with the downstream signal at the second port of the FDX amplifier. The system may determine an initial upstream signal input associated with the FDX amplifier, wherein an upstream signal traverses the configuration system associated with the FDX amplifier, and wherein the configuration system configures at least one of a gain and a loss associated with the upstream signal. The system may determine a path gain associated with the upstream signal traversing from a second output of the configuration system to the first port of the FDX amplifier. The system may determine at least one of an equalization and an operational gain associated with the upstream signal at the first port of the FDX amplifier.

This summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of the disclosure.

### BRIEF DESCRIPTION OF THE DRAWINGS

The following detailed description is better understood when read in conjunction with the appended drawings, wherein like reference numbers refer to like elements throughout, unless specified otherwise. For the purposes of illustration, examples are shown in the drawings; however, the subject matter is not limited to specific elements and instrumentalities disclosed. In the drawings:

FIG. 1 shows an example system.

FIG. 2 shows an example system.

FIG. 3 shows an example system.

FIG. 4 shows an example system.

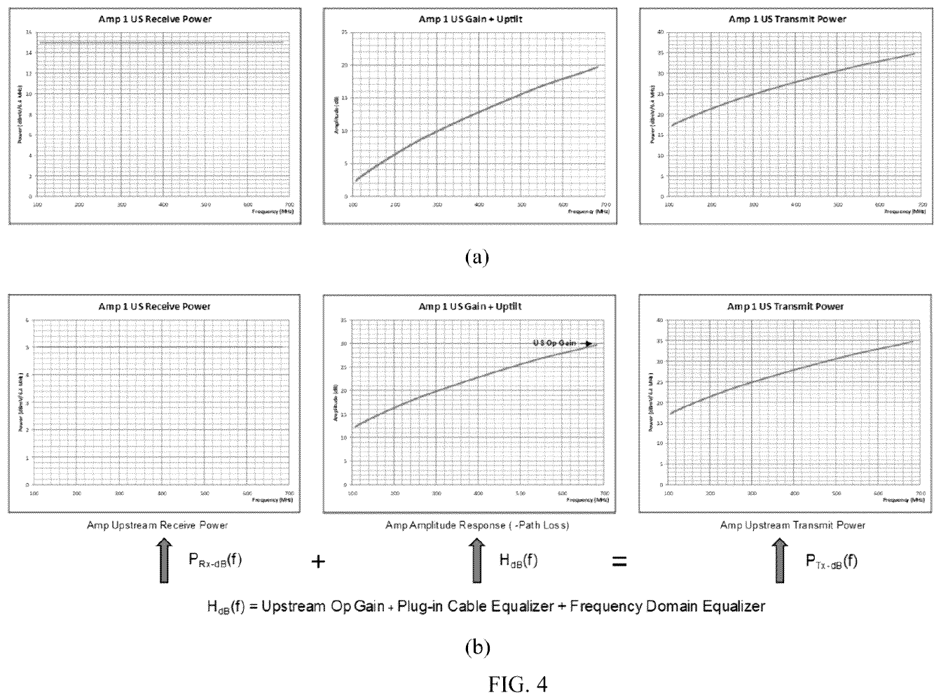

FIG. 5 shows an example system.

FIG. 6 shows an example system.

FIG. 7 shows an example system.

FIG. 8 shows an example system.

FIG. 9 shows an example system.

FIG. 10 shows an example system.

FIG. 11 shows an example system.

FIG. 12 shows an example system.

FIG. 13 shows an example system.

FIG. 14 shows an example system.

FIG. 15 shows an example system.

FIG. 16 shows an example system.

FIG. 17 shows an example system.

FIG. 18 shows an example system.

FIG. 19 shows an example system.

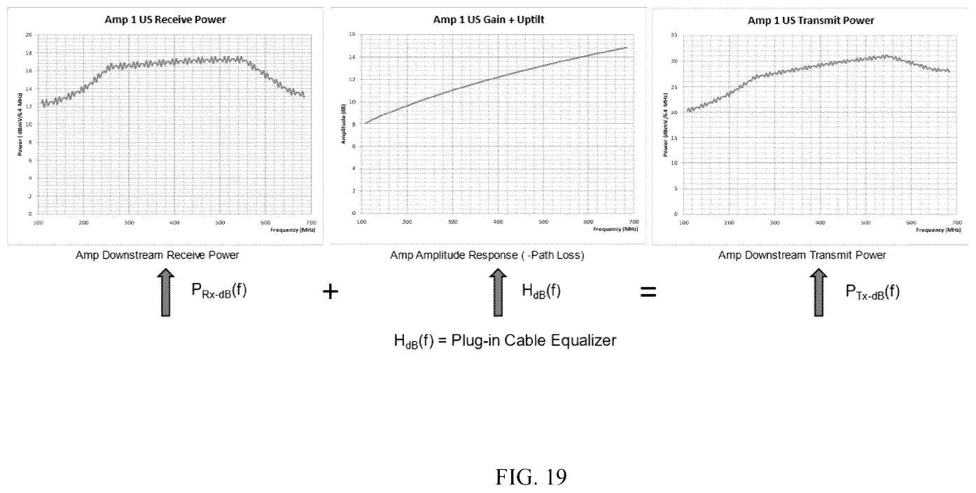

FIG. 20 shows an example system.

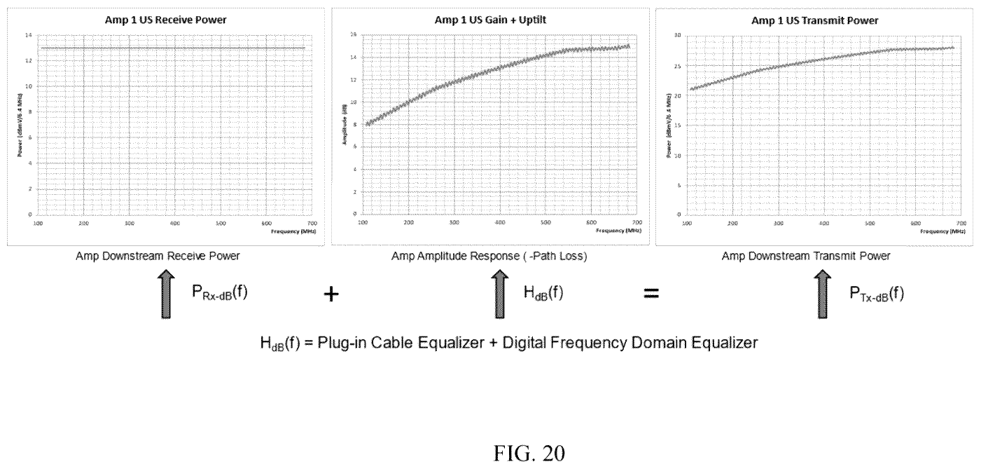

FIG. 21 shows an example system.

FIG. 22A shows a first portion of an example system, continued in FIG. 22B.

FIG. 22B shows a continued portion of the example system of FIG. 22A.

FIG. 23 shows an example system.

FIG. 24 shows an example method.

FIG. 25 shows an example method.

FIG. 26 shows an example method

FIG. 27 shows an example computing system.

### DETAILED DESCRIPTION

The following abbreviations may be used herein.

| | |
|---|---|
| AC | alternating current |
| ADC | analog to digital converter |
| ADU | automatic drive unit |
| AFE | analog front end |
| Amp | amplifier |
| AP | access point |
| ATT | attenuator |
| BPF | band-pass filter |
| bps | bits per second |
| DAC | digital to analog converter |
| DC | direct current |
| DOCSIS | data over cable service interface specification |
| DS | downstream |
| DSP | digital signal processing |
| EC | echo cancellation |
| eCM | embedded cable modem |
| EQ | equalizer |
| FDD | frequency division duplex |
| FDX | full duplex DOCSIS |
| FEC | forward error correction |
| FFT | fast fourier transform |
| FR | frequency response |
| HD | high definition |
| Hz | hertz |
| K | kelvin |
| op gain | operational gain |
| PA | power amplifier |
| RF | radio frequency |
| R-PHY | remote physical RF layer |
| Rx | receive |
| SCTE | Society of Cable Telecommunications Engineers |
| SoC | system on chip |
| TCP | total composite power |
| Tx | transmit |
| US | upstream |

FDX technology has been realized in a custom SoC successfully implemented in an operational FDX R-PHY node design. A new implementation of the SoC is also being adapted for use in an FDX amplifier utilizing the same echo cancellation technology employed in the node.

FDX amps may replace conventional mid-split amps and may support concurrent bidirectional communication within the same bandwidth. The amps are more complex to configure for FDX operation. Substantially new and more complicated methods for configuring the amplifiers are needed to install the amps. Additionally new methods to maintain proper operation of the new amplifiers will be needed.

DOCSIS 4.0 FDX amplifiers with embedded digital signal processing provides the ability to automatically configure the amp for FDX operation replacing the manual alignment process in conventional amps today. Optimal results for cascades of amps may be obtained resulting in near perfect amp alignment that is otherwise not possible.

The heart of the FDX amps use digital signal processing (DSP) in a custom SoC that digitizes inbound and outbound signals with flexible processing of the required amplifier gain, equalization, and echo cancellation (EC).

Several test points and a wideband FFT processor for spectrum analysis are included in the SoC in addition to the required DSP for digital filtering, EC, and FFT signal processing. The digital test points may be processed by the wideband FFT for spectrum analysis. Such processed spectral data may be communicated through an embedded cable modem (eCM) in the SoC, as well as loading data as the result of processing the spectrum data for configuring proper amplifier operation. The alignment process for technicians may be simplified through automation via a communication link between the amp and a configuration server using internal amp measurements that are described herein.

This disclosure discusses a method for automatically configuring an FDX amplifier for optimal operation using the spectral analysis capability and DOCSIS communication in the SoC. Additionally, a method for discovering the network topology of the amplifiers in a tree and branch network is derived. Such methodologies may also be used to initially set up and periodically check for continued proper operation of installed and configured amplifiers.

### FDX Amplifier Design

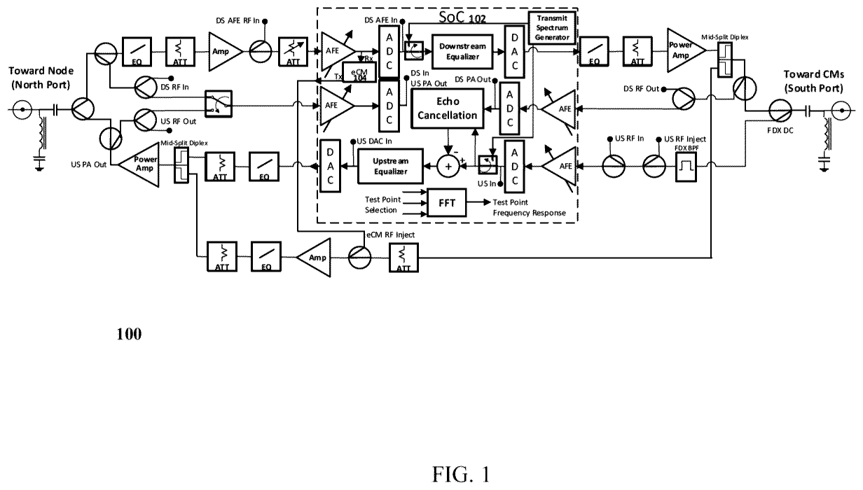

A functional diagram of an FDX amplifier is shown in FIG. 1. This amplifier functionally comprises much of a conventional Frequency Division Duplex (FDD) amplifier with the diplex filters replaced by directional couplers or splitters to enable simultaneous bidirectional spectral occupancy in the FDX band. The insertion of a System on a Chip (SoC) 102 provides echo cancellation (EC) of the downstream signal echo into the upstream signal and digital signal processing (DSP) features such as digital equalization of upstream and downstream signals. A DOCSIS embedded cable modem (eCM) 104 enables communication between the amp and a central controller (“Amp Central”) to provide network operational parameters and control amplifier setup and determination of network topology of the amplifier cascades within the tree and branch system architecture. The mid-split upstream path is separated via diplex filters and does not pass through the SoC 102 to facilitate network connectivity of the eCM 104 within the SoC 102.

A Fast Fourier Transform (FFT) for frequency response (FR) calculations of signal test points is provided within the SoC 102. Various test points within the SoC 102 are identified in FIG. 1. FIG. 1 describes an FDX amplifier functional diagram. An FFT may be applied to any selected test point to calculate the test point signal FR. Such calculated FRs along with configuration file FRs of the paths between the amp ports and the SoC 102 are used to determine automatic equalization DSP coefficients (in frequency and/or time domain) in the SoC 102 to augment conventional gain and equalization within the amp signal paths between the SoC 102 and the amp ports.

### FDX Initial Amplifier Install and Setup

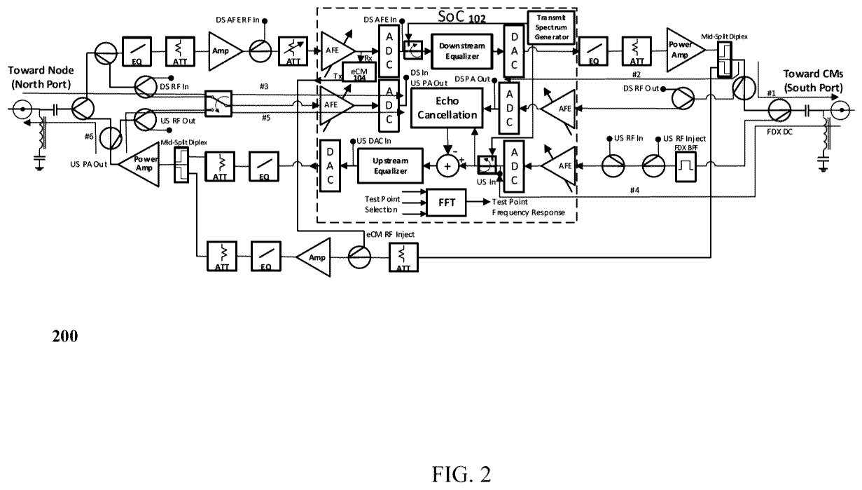

Configuration file paths #1 through #6 are described in FIG. 2. Each configuration file comprises a frequency response measured at the time of manufacture and stored into memory of the amp. The configuration files may be used to calculate the levels at the amplifier ports given measurements of an SoC 102 internal test point frequency responses. The calculations and the resultant calibration of the gains and equalization both internal and external to the SoC 102 are discussed herein.

### Initial Amp Setup to Enable SoC eCM Activation

Initial Boot-up and Downstream Input Setup: Assume that an existing amp is being replaced. The following method will setup an initial downstream input to the FDX amp SoC 102 and enable the eCM 104 to establish connectivity with Amp Central as follows:
1) Replace the amp housing (new) or RF lid (existing) with AC power shunts initially removed, then reinstall upon completion of the replacement.
2) Power-up and boot the RF board and SoC module to set the default state for RF South Port DAC attenuator and equalizer (EQ) and SoC configuration default states for North port Analog Front End (AFE), South port DAC, North port DAC, South port US and DS AFEs.
3) Set ADU to manual.
4) Measure spectrum and total composite power (TCP) at DS AFE RF In test point with (measurement) meter tool across test frequencies.
5) Calculate and set DS in attenuator and equalizer (EQ) for approximately a flat level across frequency≤TCP limit including North AFE backoff attenuator (0 dB default) at the DS AFE RF In input for best ADC performance.
6) Measure and adjust the ADU pilot level attenuation in auto mode to match manual mode.

### Legacy Upstream Input Setup:

1) Consult design reference for return input attenuation value.
2) Set default state for legacy US input attenuator, US output attenuator, and US output equalizer (EQ).
3) Legacy upstream plug-ins could use previously installed amplifier values initially.
4) Adjust legacy US output attenuator to add to input attenuator to match design reference value at DS RF Out FR=South Port upstream input FR+Config #1 FR—Config #2 FR.

The SoC eCM locks with a positive status indicator and establishes connectivity to Amp Central. Automatic calculation may proceed with this communication path established. Calculations and results may be handled in Amp Central or CPU processors in the amp or in the SoC (in addition to internal signal test point FFTs).

### SoC Downstream Gain and Equalization Optimization

Initial Downstream Setup for Mid-Split Operation: The eCM is online and may query Amp Central for downstream transmit output level and tilt and the upstream receive input level. Proceed to set the initial gain and tilt excluding the SoC as follows:
1) Command SoC downstream path gain and equalization to 0 dB flat across the downstream band. Initially no influence by the SoC digital equalizer, just use conventional or electronic plug-ins (a fixed default SoC non-zero dB gain and tilt can also be used).
2) Measure SoC DS PA out FR downstream output level and tilt values.
3) Calculate South Port-to-DS PA out path loss FR=Config #2 FR—Config #1 FR. Config file FR paths described in FIG. 2.
4) Calculate South Port output FR=DS PA out FR-South Port-to-DS PA out path loss FR
5) Set downstream output attenuators and equalizer (EQ) to approximate design output level and tilt.
6) Check output level and tilt by remeasuring the South Port output FR=DS PA Out FR-South Port-to-DS PA out path loss FR.

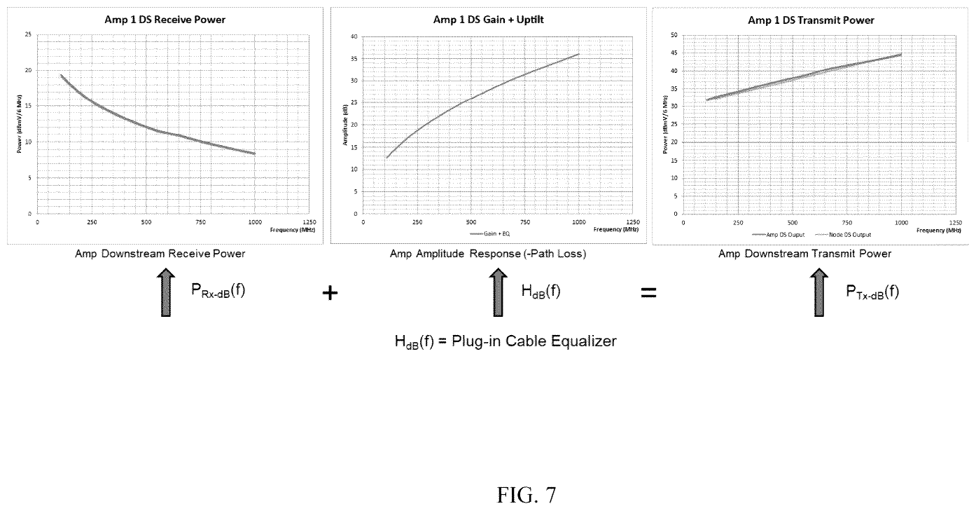

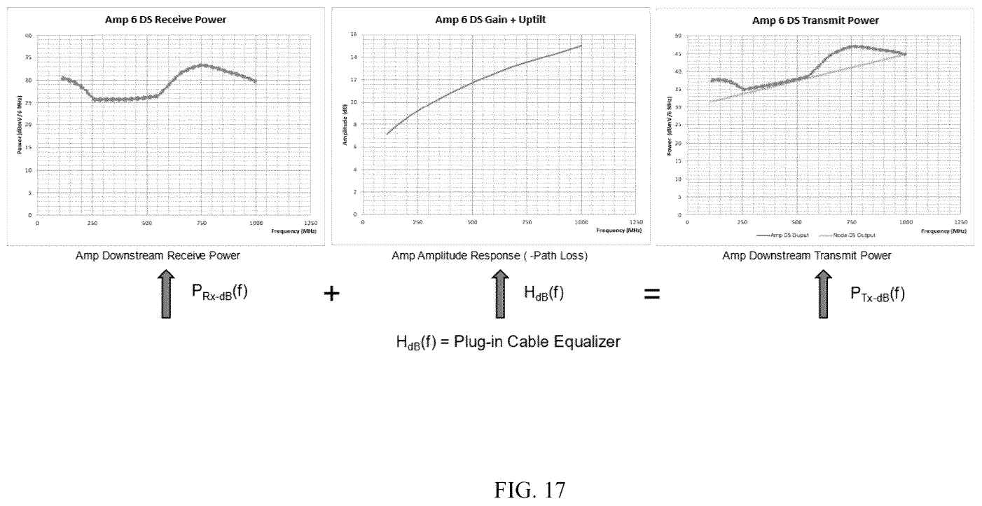

The described initial setup with pass through of the signal through the SoC essentially sets up the downstream with conventional attenuators and equalizers as is done in conventional (analog) amps. As described herein and shown in FIGS. 7, 9, 15, and 17, this approximates the design level and tilt design profile and passes any input linear distortion (amplitude variation) to the output signal. The following portion of the disclosure describes a process for removal of such artifacts.

### Downstream Output Optimization Using SoC Downstream Equalizer

The design level and tilt design profile are restored and any input linear distortion (amplitude variation) to the output signal is removed as follows:
1) Measure SoC DS in FR and SoC DS AFE in FR
2) Set North Port-to-DS in FR=Config #3 FR
3) Calculate North Port DS input FR=DS in FR-North Port-to-DS in FR
4) Calculate Inter-Amp Span Loss FR=North Port DS input FR-Node/Amp output design FR. Node/Amp output design FR=Node/Amp downstream output design level and tilt FR
5) Calculate North Port-to-DS AFE in FR=DS AFE in-North Port DS input FR
6) Calculate SoC DS DAC Out-to-South Port FR=DS AFE in FR-South Port output FR. DS DAC input FR=DS AFE in FR (+SoC default gain and tilt FR if not 0 dB).
7) Calculate DS Equalization+Gain FR=−Inter-Amp Span Loss FR
8) Calculate DS Op Gain (>0 dB) for DS Equalizer response (≤0 dB). DS Op Gain=|DS Equalizer+Gain FR @maximum DS frequency|
9) Calculate DS Equalization FR=−(Inter-Amp Span Loss FR+DS Op Gain)

DS Equalization FR+DS Op Gain=North Port-to-DS AFE in FR+SoC Downstream Equalizer FR+DS DAC input-to-South Port FR
10) Set SoC DS Equalizer FR=DS Equalization FR+DS Op Gain-North Port-to-DS AFE in FR-DS DAC input-to-South Port FR

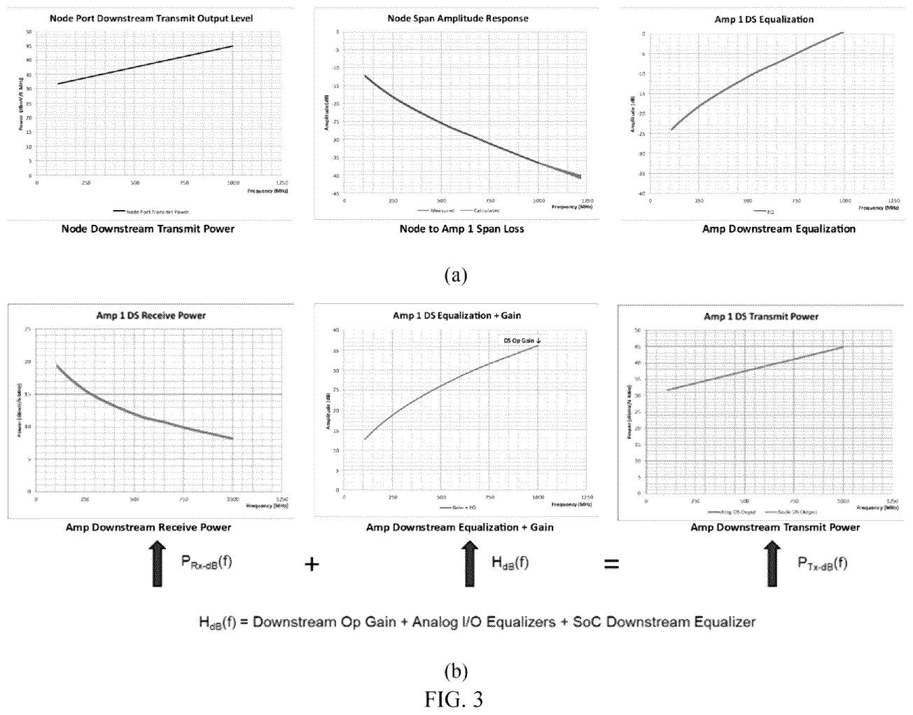

An example depicting the DS Equalization+Gain FR, the Op Gain, and DS Equalization FR calculation steps above that are needed for determining the SoC DS Equalizer FR is shown in FIG. 3.

The node transmitted downstream output FR is shown in the left plot of FIG. 3a. The amp received downstream input FR is shown in the leftmost plot of FIG. 3b. The DS Equalization+Gain FR and DS Op Gain are shown in the center plot of FIG. 3b. The output FR (i.e., the level and tilt) matches that of the negative inverse of the inter-amp span loss in the center plot of FIG. 3a. The downstream equalization calculation without the op gain is shown in the right plot of FIG. 3a. The amp downstream output transmit FR is shown compared to the node downstream output transmit FR in the right plot of FIG. 3b. The downstream output FR (i.e., the level and tilt) matches that of the node with a final 37 dB amp downstream operational gain.

The amp output transmit FR can be arbitrarily set by substituting the desired amp output transmit profile for the node transmit profile in step 4 in the above method: 4) Calculate Inter-Amp Span Loss FR=North Port DS input FR—desired Amp output design FR.

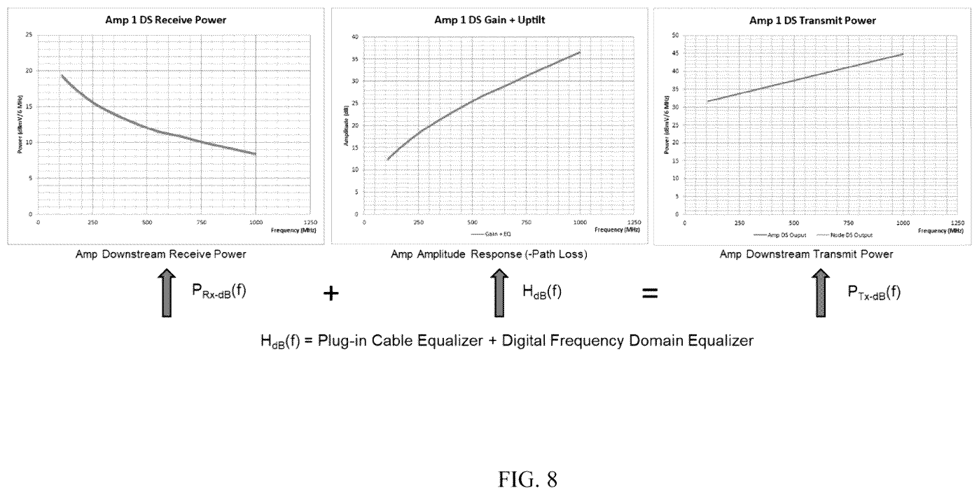

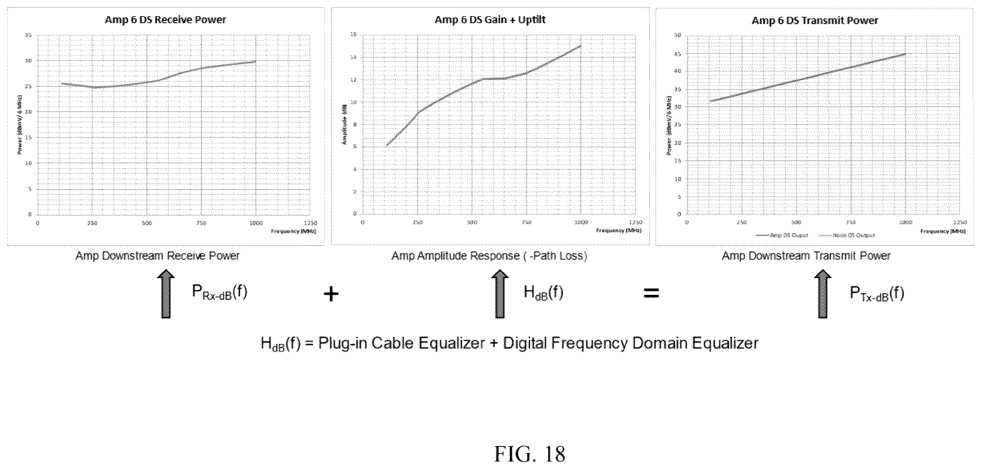

This final setup with activation of the SoC downstream (digital) equalizer and final gain setting achieves the design level and tilt design profile and removes any input linear distortion (amplitude variation) to the output signal. Examples demonstrating this result are described herein, for example in FIGS. 8, 10, 16, and 18.

### SoC Upstream Gain and Equalization Optimization

The following sections describe a similar process for the upstream. This is possible since the upstream and the downstream share the same spectrum with the same amp span loss from the amp North Port to the Node Port since the path loss is the same in either direction (symmetry).

### Initial Upstream Output Setup for FDX Operation

1) Command SoC upstream path gain US in to US DAC in to 0 dB flat across the upstream band (a fixed default SoC non-zero dB gain and tilt can also be used). Initially no influence by the SoC digital equalizer (or default known non-zero gain and tilt), just use conventional or electronic plug-ins.
2) Set South Port-to-SoC US in FR=Config #4 FR.
3) Set US out-to-North Port FR=Config #6 FR.
4) Calculate South Port to North Port Amp FR=−Inter-Amp Span Loss FR (symmetric insertion loss).
5) Calculate US Op Gain (>0 dB) for US Equalizer FR (≤0 dB)=|US Equalizer+Gain FR @ maximum US frequency|.
6) Calculate US Equalization FR=(US Op Gain+Inter-Amp Span Loss FR).
7) Calculate US Power Amp Gain=US Op Gain-South Port-to-SoC US in FR—US PA out-to-North Port FR and set upstream output attenuator.
8) Select plug-in or set electronic US EQ FR≈US Equalization FR (match cable EQ uptilt).

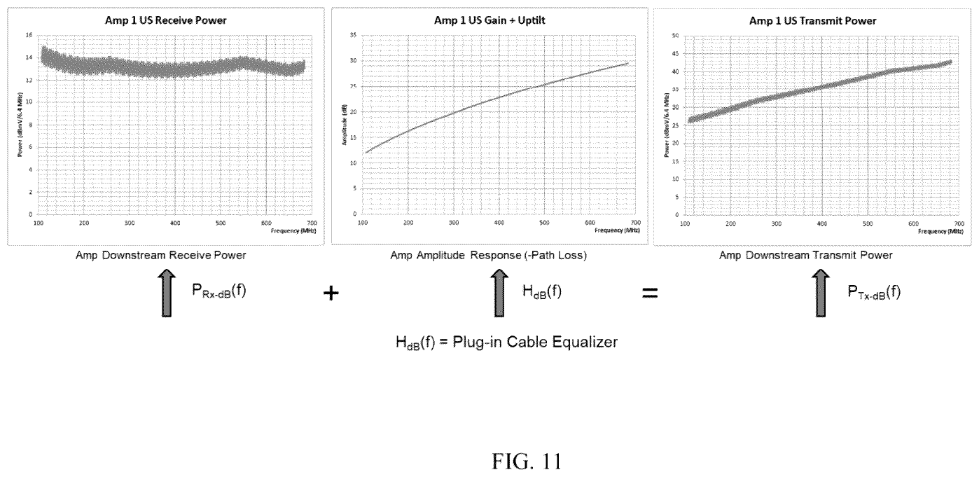

An example depicting the US Equalization+Gain FR, the Op Gain, and US Equalization FR calculation steps above that are needed for determining the SoC US Equalizer FR is shown in FIG. 11. The US Equalization+Gain FR and US Op Gain at the maximum upstream frequency are shown in the center plot of FIG. 11. The output FR (i.e., the level and tilt) approximately matches that of the negative inverse of the inter-amp span loss. The amp upstream output transmit FR is shown in the right plot of FIG. 11. The amp received upstream input FR is shown in the left plot of FIG. 11. The node port upstream input level to be matched at the amp upstream input (South) port is 13 dBmV/6.4 MHz.

This approximates the upstream input design level and passes any input linear distortion (amplitude variation) to the output signal. A cable modem transmitting towards the amp south port will transmit with pre-equalization to be received at the node port with a flat level without linear distortion. The upstream input FR (i.e., the level and tilt) approximates that of the node since the amp has not applied upstream equalization in the SoC to reduce the CM linear distortion due to pre-equalization.

### Upstream Input Optimization Using SoC Upstream Equalizer

Completion of the upstream input optimization is accomplished by setting the SoC upstream equalizer to correct the deviation of the US EQ FR from the ideal US Equalization FR calculated in the previous section as follows:
1) SoC Upstream Equalizer FR+US EQ FR=US Equalization FR.
2) Set SoC Upstream Equalizer FR=US Equalization FR—US EQ FR. SOC corrects any deviation of US EQ FR from US Equalization FR.
3) FDX upstream path configuration complete.

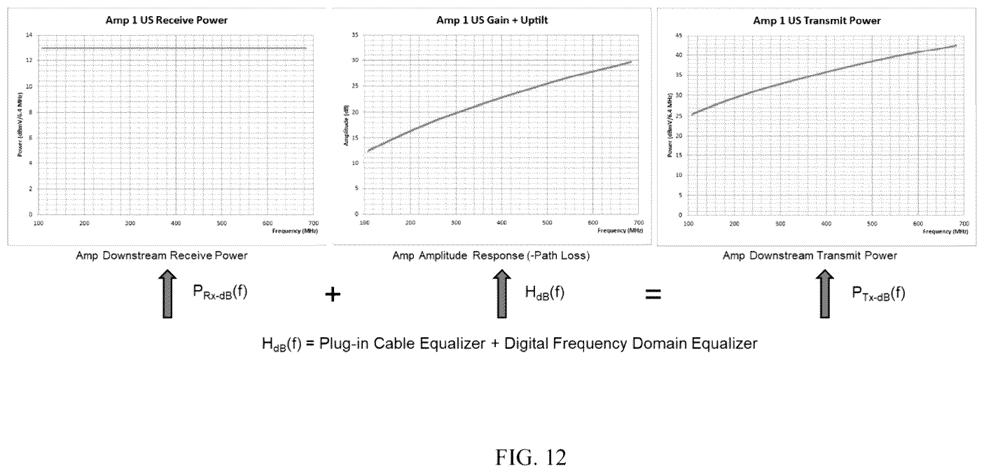

FIG. 12 shows the effect of the SoC upstream equalizer on the previous example. The US Equalization+Gain FR and US Op Gain at the maximum upstream frequency are shown in the center plot of FIG. 12. The output FR (i.e., the level and tilt) now matches that of the negative inverse of the inter-amp span loss. The amp upstream output transmit FR is shown in the right plot of FIG. 12. The amp received upstream input FR is shown in the left plot of FIG. 12. The node port upstream input level to be matched at the amp upstream input (South) port is 13 dBmV/6.4 MHz.

Proceed next to Network Amplifier Topology Discovery after all amps in the node leg have been configured and before Final Downstream and Upstream Optimization of All Amps.

### Network Amplifier Topology Discovery

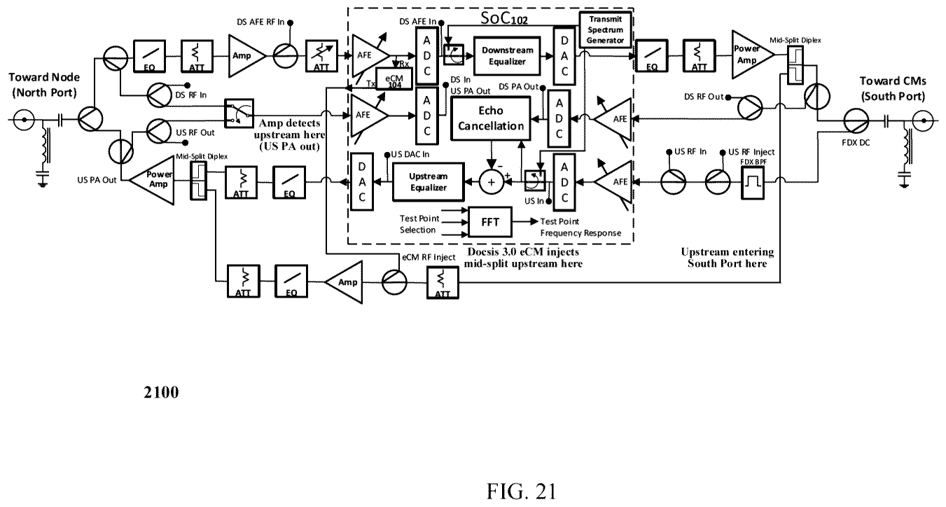

A functional diagram of an FDX amplifier with topology discovery paths is shown in FIG. 21. Network topology may be determined using each FDX amplifier embedded cable modem as shown in FIG. 21 to transmit in the mid-split upstream individually in turn in any order. During each such transmission, all amps that detect the transmission in the SoC US PA out test point are connected in the upstream path between the transmitting amp and the node. Note that the transmitting amp will also receive its own injected transmission into the mid-split upstream path.

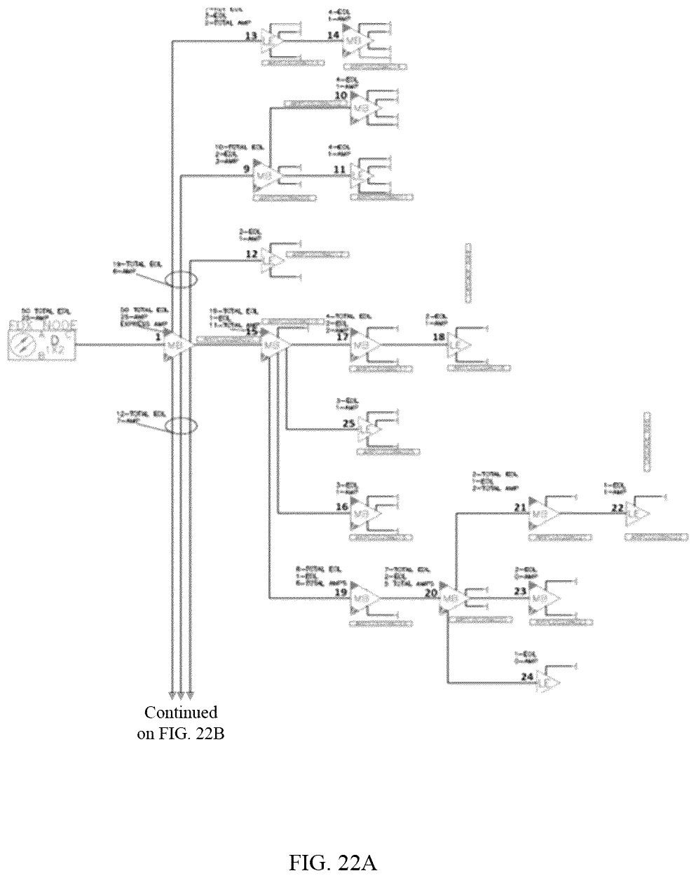

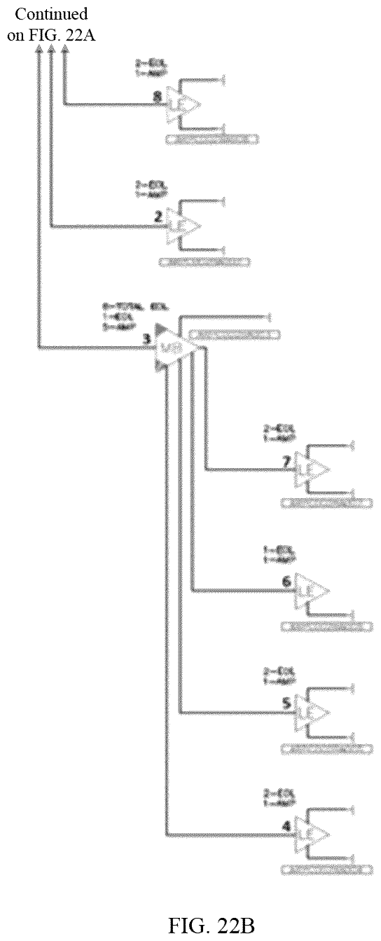

An example tree and branch network diagram of a Comcast cable plant depicting amplifier cascade connectivity is shown in FIG. 22. A single port is connected to 25 amplifiers with a maximum cascade depth of 6 (Node+6). Each amp has a single downstream input. An amp may have multiple downstream outputs (e.g., 1) which are also multiple upstream inputs. Splitters/directional couplers may also combine paths which are external to the amplifier port(s) but are considered direct connections to the amplifier. Either a direct or a combined path between amps is a network connection.

Such topology may be represented as a linear graph. Linear graphs are commonly used to describe electrical network topology with associated cut-set (Kirchoff Current Law) or loop-set (Kirchoff Voltage Law) matrices. Network elements (e.g., R, L, and C) are represented as nodes with connections between nodes represented as edges. A non-zero matrix element indicates an edge connection between nodes.

For determining network topology of amplifier connections, a similar principle may be applied. Each amp in the cable network is a “node,” and each input or output connection between amps is an “edge.” Network topology is represented as a matrix of unidirectionally edge connected nodes from each end-of-line amplifier toward the FDX node.

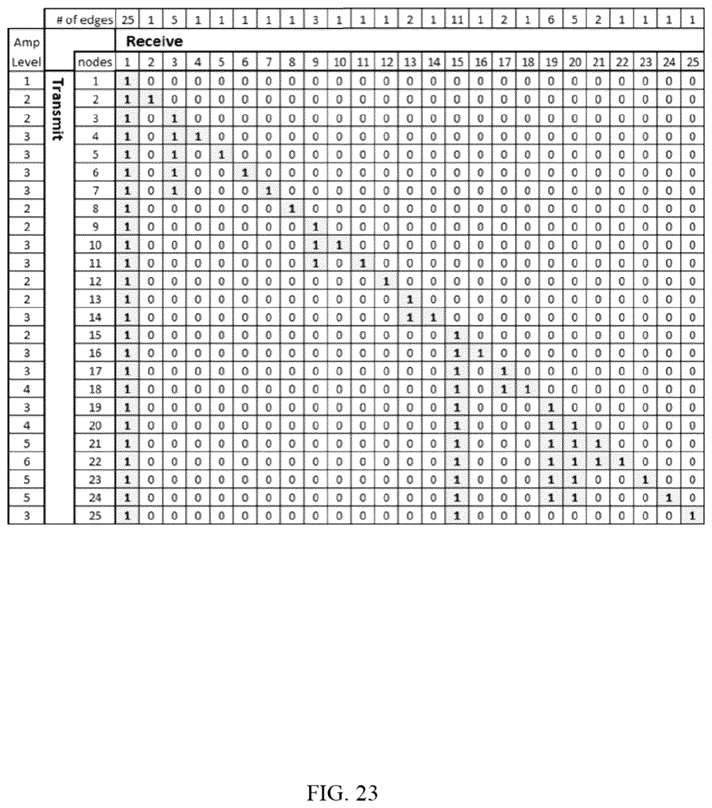

A linear graph matrix describing such edge connections of amp nodes between each transmitting amp and all receiving amp nodes in the path toward the cable system fiber node for the network of FIG. 22 is shown in FIG. 23. A non-zero row element in the matrix denotes an edge connecting amps in the path between and including the transmitting amp and the root amp connected directly to the fiber node. Each “1” cell represents a mid-split upstream transmission in a row amp that is received by any other column amps. For example, node row 14 indicated that this amp transmission may be heard by receiving column node amps 13 and 1 (as well as itself).

Some properties of this matrix may be used to determine the network topology of all amp cascades from an end-of-line amp to the fiber node. The row sum is equal to the quantity of amps that received the transmission of that row amp. That quantity of receiving amps toward the node is the cascade depth of the transmitting amp in a network branch. The column sum is equal to the quantity of nodes whose transmissions were received by a given node (including itself). For example:
1) The column of amp 14 did not receive any other amp transmission except itself (a single “1” in row 14) and is therefore at the end-of-line of a network branch.
2) The column of amp 13 received a transmission only from itself and amp 14 (rows 13 and 14).
3) The column of amp 1 received transmissions from every amp in the network, i.e., amp 1 is the root amp of the network tree (cascade level 1) connected to the fiber node.

A branch starts at an end-of-line amp where the quantity of edges in the column sum is equal to 1, that is, there are no amps downstream of this amp. Each amp in the branch (cascade) from that end-of-line amp to the root amp (connected to the node) has a non-zero cell in the row of that end-of-line amp.

To determine network topology, sort each non-zero cell amp in the end-of-line amp row in decreasing order (from the end-of-line amp to the root amp) according to the row sum (amp level) of each non-zero amp in the row. For example:
1) amp (node) 14 # of edges=1 and is at a branch end-of-line.
2) node row 14 connects with edges to node columns 13 and 1.
3) node row 14 sum (amp cascade level)=3.
4) node row 13 sum (amp cascade level)=2.
5) node row 1 sum (amp cascade level)=1.
6) Therefore, the path of this branch from the end-of-line (amp level 3) to the root (amp level 1) is 14, 13, 1 as shown in Table 1.

TABLE 1
Network topology describing the Tree and Branch cable network of FIG. 22
Network Topology for Node + 6

| | | | | | | | | | | | | | | | | |
|---|---|---|---|---|---|---|---|---|---|---|---|---|---|---|---|---|
| End of Line Amps: | 2 | 4 | 5 | 6 | 7 | 8 | 10 | 11 | 12 | 14 | 16 | 18 | 22 | 23 | 24 | 25 |
| Toward Node ↓ | 1 | 3 | 3 | 3 | 3 | 1 | 9 | 9 | 1 | 13 | 15 | 17 | 21 | 20 | 20 | 15 |
| | | 1 | 1 | 1 | 1 | | 1 | 1 | | 1 | 1 | 15 | 20 | 19 | 19 | 1 |
| | | | | | | | | | | | | 1 | 19 | 15 | 15 | |
| | | | | | | | | | | | | | 15 | 1 | 1 | |
| | | | | | | | | | | | | | 1 | | | |

### Final Downstream and Upstream Optimization of All Amps

After completing Network Amplifier Topology Discovery, repeat previous Downstream and Upstream Optimizations successively from ALL level 1 to level x amps. Each amp at level n initially relies on the downstream output profile of amp n−1 matching that of the node. This is only true if FDX amps are configured successively from the node toward the end of line. Configuring amps in any other order will measure conventional amplifier downstream output profiles which may differ from that of the node resulting in some deviation from the node downstream output level profile. A second pass configuration in order from the node toward the end of line (N+1 to N+x) corrects any such deviations resulting in each amplifier downstream output matching that of the node.

Each amplifier upstream gain and FR can now be precisely adjusted by using a transmit spectrum generator signal from each end-of-line amplifier as follows:

Check Amp/Node upstream receive level with SoC Transmit Spectrum Generator (FIG. 1):
1) Query Amp Central for Node/Amp Port FDX upstream input level (constant value over frequency).
2) Set Transmit Spectrum Generator level successively at each end of line amp=FDX upstream input level+<South Port-to-SoC US in FR>.

Check upstream alignment (and redo if needed) from the end of line toward the node:
1) From back to front from amp cascade level x to 1 for a N+x system after network amp topology discovery.
2) Turn on the Transmit Spectrum Generator signal in the FDX upstream band on the end of line amp x.
3) Successively check each amp upstream receive level at amp x−1,x−2, . . . , 1 at SoC US in test point in each cascade path from each end of line amp x.
4) Check for each amp received upstream input level at SoC US in FR=Node/Amp Port FDX upstream input level FR, where the Node/Amp Port FDX upstream input level FR should be a constant value over frequency.

### Example Auto Setup of Cascaded FDX Amplifier Networks

The methodology discussed for automatically configuring FDX amplifiers designed with DSP in the SoC of FIG. 1 is applied to two examples of amplifier cascades in cable systems. Firstly, to a suburban system of single family units with distributed taps separated about 100 feet apart with amps spaced about 800 or more feet in a 6 amp cascade. Secondly, to an urban multiple dwelling unit, multi-story building with 4 or more back-to-back tap clusters separated about 45 feet apart with 8 taps per amplifier spacing of about 50 feet for each group of 6 floors.

These two types of systems have significantly different frequency response characteristics that present different challenges to amplifier setup and equalization due to the different mix of cable lengths and tap spacing. However, the methods previously discussed will be shown to achieve virtually identical amplifier input and output levels to the node uniformly to each amp in the cascade with greatly reduced linear distortion build-up present in conventional amp cascades.

### Single Family Unit (SFU) Model of a Node and 6 Amp Cascade

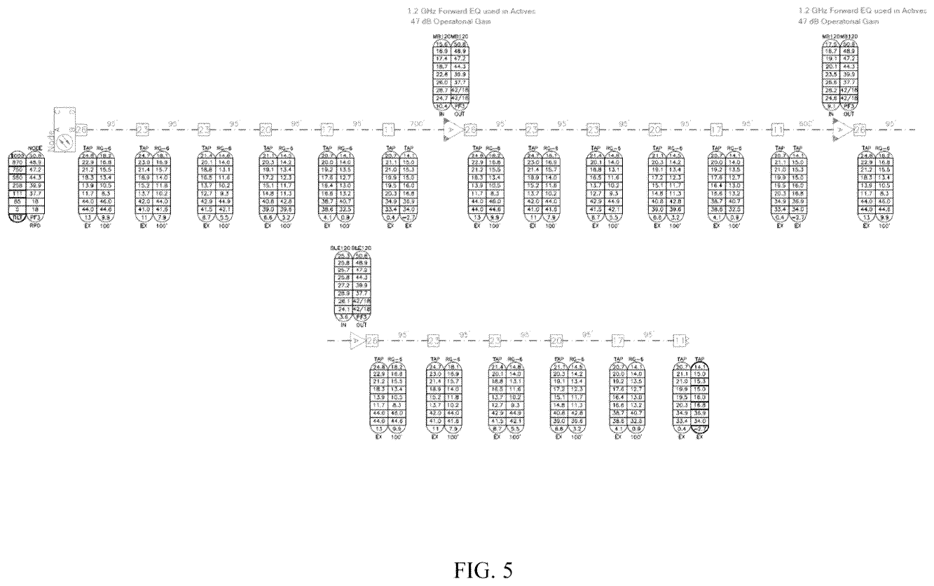

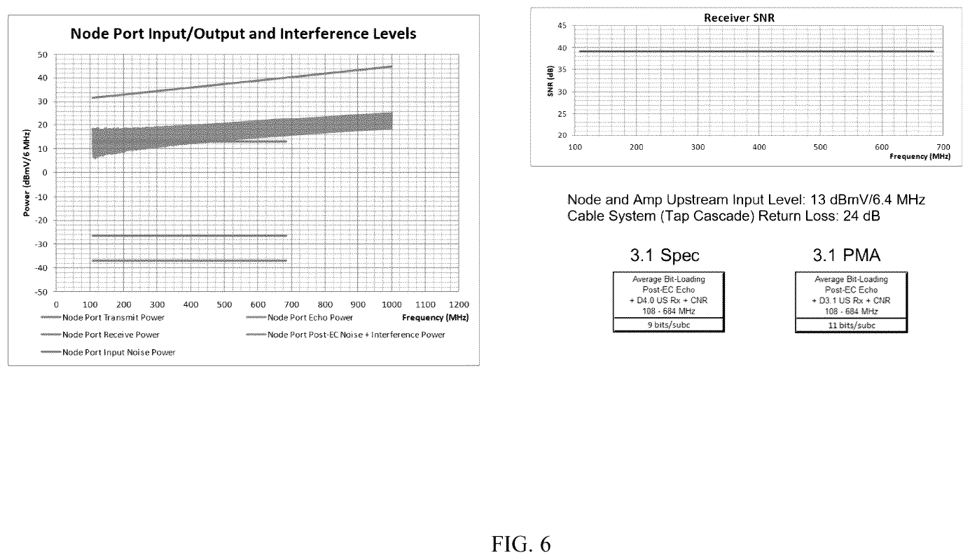

An example of a Node+6 SFU system is shown in FIG. 5. The node port input/output and echo interference levels, upstream received SNR, and resultant bit-loading is shown in FIG. 6. FIG. 6 describes SFU node port input/output and echo interference levels.

The method for initial downstream setup for mid-split operation of the amplifiers was applied to Amp 1 of the SFU system of FIG. 5. This initially set up the attenuators and equalizers with SoC passthrough of the downstream signal. The result in FIG. 7 for the Amp 1 downstream gain plus uptilt on the downstream received input yields the downstream transmitted output shown. Note the amp output slightly deviates from the node transmitted signal frequency response.

The method for final optimized downstream setup of the amplifiers using the digital equalizer in the SoC was applied. The result in FIG. 8 for the Amp 1 optimized downstream gain plus uptilt on the downstream received input yields the downstream transmitted output shown. Note the amp output deviation from the node transmitted signal frequency response has been eliminated by the SoC digital equalizer action.

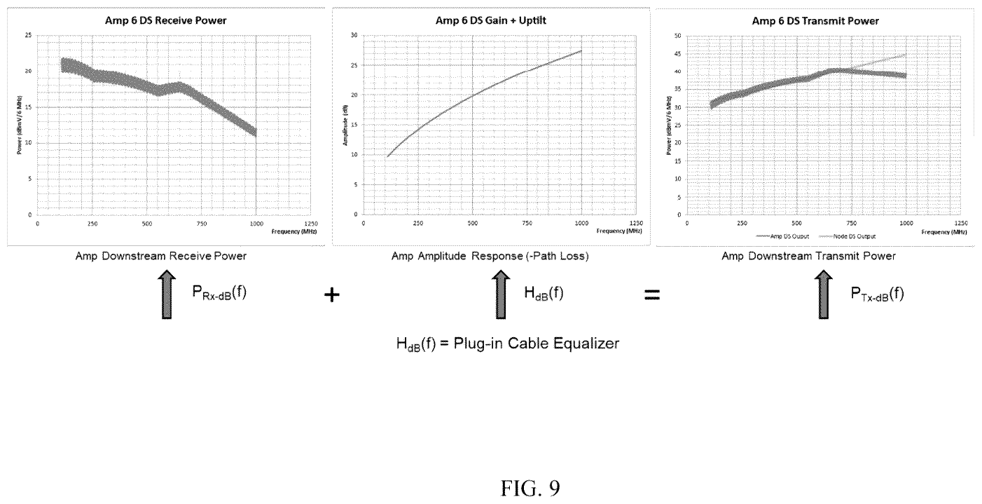

The method for initial downstream setup for mid-split operation of the amplifiers was applied to Amp 6 of the SFU system of FIG. 5. This initially set up the attenuators and equalizers with SoC passthrough of the downstream signal. The result in FIG. 9 for the Amp 6 downstream gain plus uptilt on the downstream received input yields the downstream transmitted output shown. Note the amp output significantly deviates from the node transmitted signal frequency response. High frequency roll-off and linear distortion (amplitude ripple) due to signal reflections increases as the downstream signal traverses through the amp cascade.

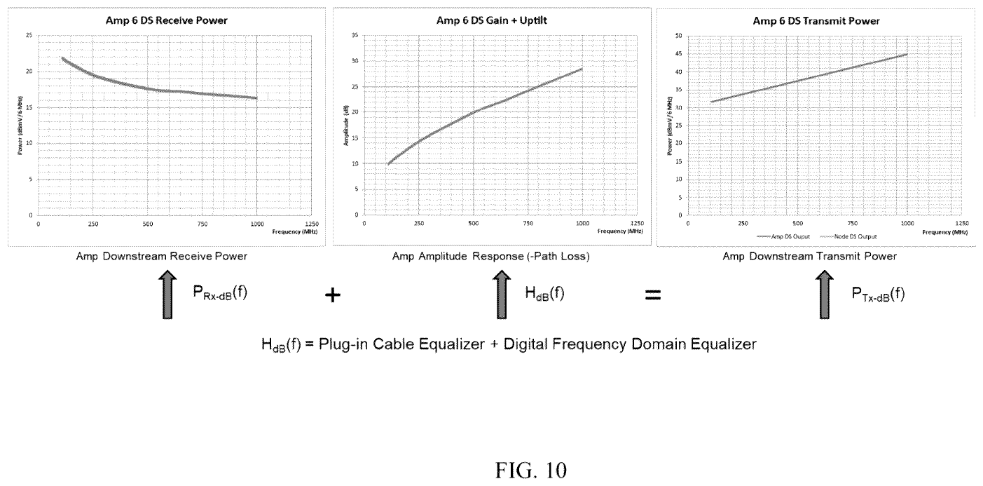

The method for final optimized downstream setup of the amplifiers using the digital equalizer in the SoC was applied. The result in FIG. 10 for the Amp 6 optimized downstream gain plus uptilt on the downstream received input yields the downstream transmitted output shown. Note the amp output deviation from the node transmitted signal frequency response has been eliminated by the SoC digital equalizer action. This is true for each amp in the cascade.

A similar method for initial upstream setup for FDX operation of the amplifiers was applied to Amp 1 of the SFU system of FIG. 5. This initially set up the attenuators and equalizers with SoC passthrough of the upstream signal. Note that in the upstream direction, Amp 1 is at the end of the upstream signal cascade. Hence this amp will have the maximum level deviation and linear distortion in the upstream. The result in FIG. 11 for the Amp 1 upstream gain plus uptilt on the upstream received input yields the upstream transmitted output shown. Note the amp input significantly deviates from the node received signal frequency response (flat level). Linear distortion (amplitude ripple) due to signal reflections increases as the upstream signal traverses through the amp cascade.

The method for final optimized upstream setup of the amplifiers using the digital equalizer in the SoC was applied. The result in FIG. 12 for the Amp 1 optimized upstream gain plus uptilt on the upstream received input yields the upstream transmitted output shown. Note the amp input deviation from the node received signal frequency response (flat level) has been eliminated by the SoC digital equalizer action. This is true for each amp in the cascade.

### Multiple Dwelling Unit (MDU) Model of a Node and 6 Amp Cascade.

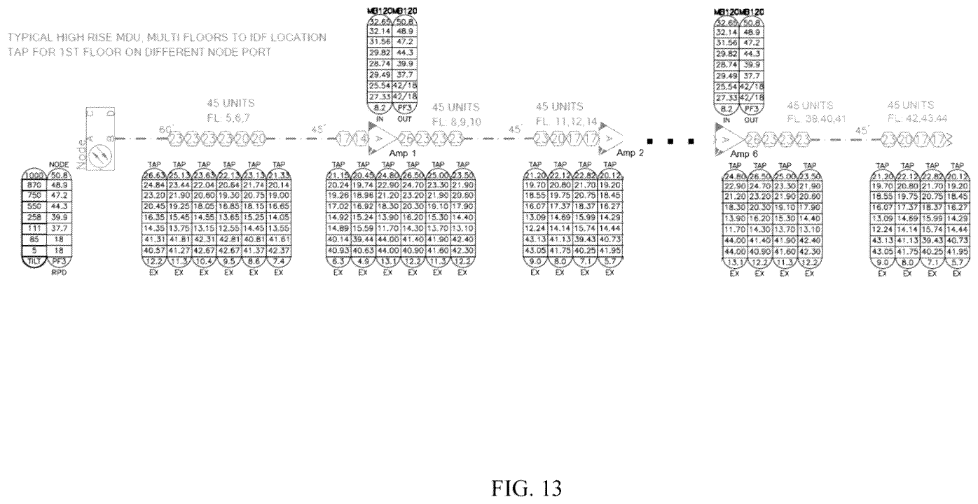

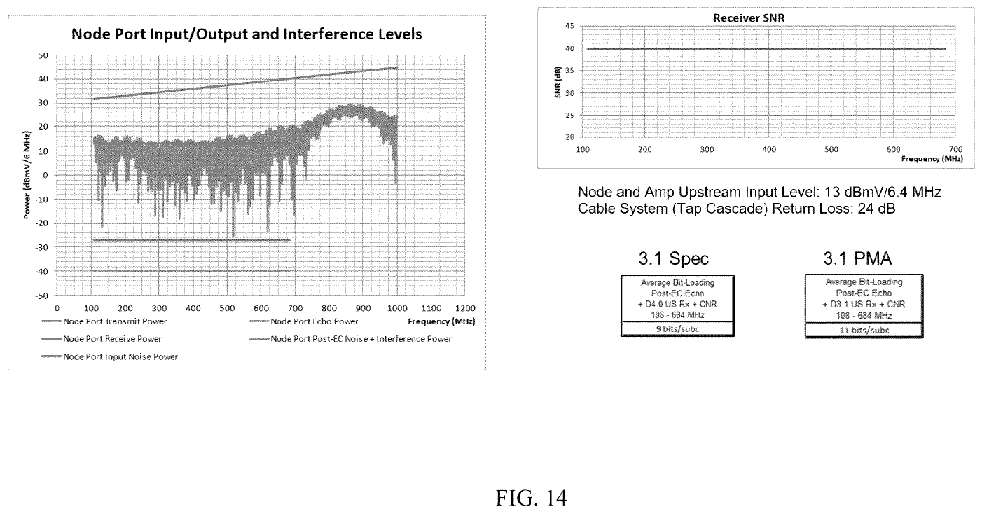

An example of a Node and 6 MDU system is described in FIG. 13. The node port input/output and echo interference levels, upstream received SNR, and resultant bit-loading is shown in FIG. 14.

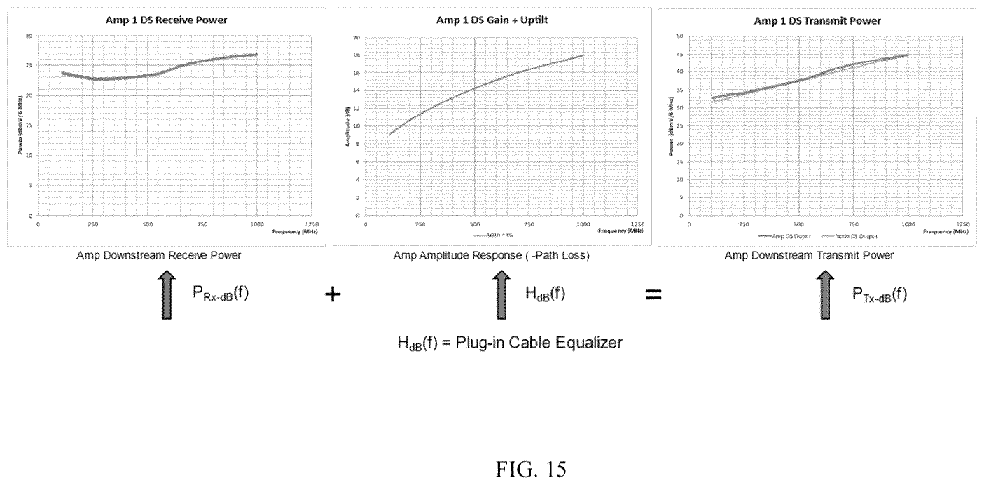

The method for initial downstream setup for mid-split operation of the amplifiers was applied to Amp 1 of the MDU system of FIG. 13. This initially set up the attenuators and equalizers with SoC passthrough of the downstream signal. The result in FIG. 15 for the Amp 1 downstream gain plus uptilt on the downstream received input yields the downstream transmitted output shown. Note the amp output slightly deviates from the node transmitted signal frequency response.

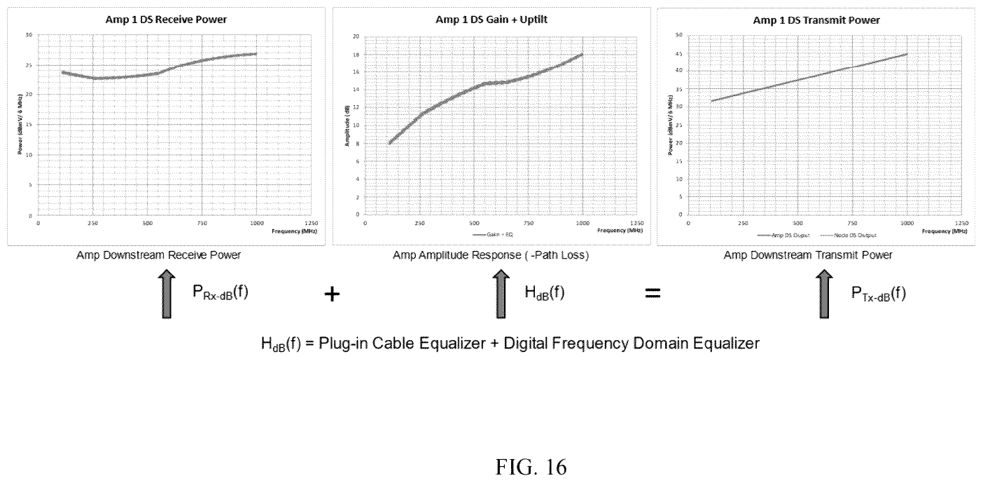

The method for final optimized downstream setup of the amplifiers using the digital equalizer in the SoC was applied. The result in FIG. 16 for the Amp 1 optimized downstream gain plus uptilt on the downstream received input yields the downstream transmitted output shown. Note the amp output deviation from the node transmitted signal frequency response has been eliminated by the SoC digital equalizer action.

The method for initial downstream setup for mid-split operation of the amplifiers was applied to Amp 6 of the MDU system of FIG. 5. This initially set up the attenuators and equalizers with SoC passthrough of the downstream signal. The result in FIG. 9 for the Amp 6 downstream gain plus uptilt on the downstream received input yields the downstream transmitted output shown. Note the amp output significantly deviates from the node transmitted signal frequency response. High frequency roll-off and linear distortion (amplitude ripple) due to signal reflections increases as the downstream signal traverses through the amp cascade.

The method for final optimized downstream setup of the amplifiers using the digital equalizer in the SoC was applied. The result in FIG. 10 for the Amp 6 optimized downstream gain plus uptilt on the downstream received input yields the downstream transmitted output shown. Note the amp output deviation from the node transmitted signal frequency response has been eliminated by the SoC digital equalizer action. This is true for each amp in the cascade.

A similar method for initial upstream setup for FDX operation of the amplifiers was applied to Amp 1 of the MDU system of FIG. 5. This initially set up the attenuators and equalizers with SoC passthrough of the upstream signal. Note that in the upstream direction, Amp 1 is at the end of the upstream signal cascade. Hence this amp will have the maximum level deviation and linear distortion in the upstream. The result in FIG. 11 for the Amp 1 upstream gain plus uptilt on the upstream received input yields the upstream transmitted output shown. Note the amp input significantly deviates from the node received signal frequency response (flat level). Linear distortion (amplitude ripple) due to signal reflections increases as the upstream signal traverses through the amp cascade.

The method for final optimized upstream setup of the amplifiers using the digital equalizer in the SoC was applied. The result in FIG. 12 for the Amp 1 optimized upstream gain plus uptilt on the upstream received input yields the upstream transmitted output shown. Note the amp input deviation from the node received signal frequency response (flat level) has been eliminated by the SoC digital equalizer action. This is true for each amp in the cascade.

Optimized amplifier gain and digital equalization demonstrate superior signal regeneration compared to analog plug-in cable equalizers. A/D, D/A, and FFT processing of signals at input and output test point interfaces in the DOCSIS 4.0 FDX Smart Amplifier SoC allow frequency domain calculation of amplifier gain and DSP-based equalization.

A multiple step algorithm for automatically configuring FDX amplifier downstream and upstream signals was described, and the resulting performance demonstrated. Optimized digital equalization that may restore node output transmission levels, tilt, and input receive levels in cascaded FDX amplifiers. Both example networks discussed demonstrate optimized digital equalization that may restore node transmission levels, tilt, and input receive level in cascaded FDX amplifiers.

A method was described for determining network amp topology using a linear graph matrix with elements determined by mid-split upstream transmission and reception of amp embedded cable modems. This method determines the amp cascade sequence order that could be used to order the automatic amp configuration process from the node to the end-of-line amp. Such methodologies may also be used to initially set up and periodically check for continued proper operation of installed and configured amplifiers.

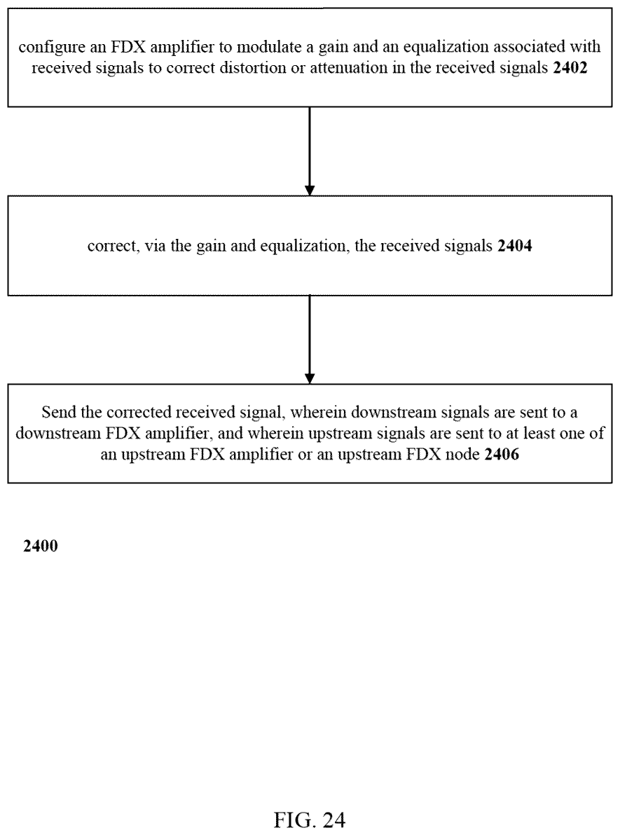

FIG. 24 shows an example method. The method described in FIG. 24 may be used by a system, for example by an FDX amplifier configuration system, to configure an amplifier to operate in a full duplex DOCSIS scheme. For example, the system of FIG. 24 may be implemented by the systems described in any one of FIG. 1, 2, 5, 13, 21, or 22. For example, the method may take place by a system on chip embedded in the FDX amplifier.

At step 2402, the system may configure, via a configuration system associated with a first FDX amplifier, at least one of an equalization or a gain associated with correcting at least one of a distortion or attenuation of a received signal, wherein the received signal comprises at least one of a downstream signal or an upstream signal. The downstream signal may be sent from a node through a cascade of downstream systems, for example consumer endpoints. For example, the node may send the signal initially to a first FDX amplifier at a first consumer endpoint, and the first FDX amplifier may send the signal to a second, downstream FDX amplifier at a second, downstream consumer endpoint. The signal may be propagated from one FDX amplifier to another FDX amplifier in the cascade of systems until eventually the signal reaches a final FDX amplifier in the cascade. The upstream signal may be sent from the final FDX amplifier back through the cascade of systems, for example the consumer endpoints. The final FDX amplifier may send the upstream signal to a next, upstream FDX amplifier in a upstream consumer endpoint. Thus, the upstream signal may be propagated from one FDX amplifier to the next until the upstream signal reaches the node.

At step 2404, the configuration system may correct, via the configured equalization or gain, the received signal. As the signal passes through the cascade of FDX amplifiers the signal may become attenuated and distorted, both within a particular FDX amplifier, as well as during the transit from one amplifier to a next amplifier in the cascade. For example, echo from the downstream signal may distort the upstream signal, and echo from the upstream signal may distort the downstream signal. Therefore, to maintain suitable signal conditions, the FDX amplifier may be configured to correct the altered signal at each amplifier in the cascade. The signal may be corrected via one or more of an equalization or a gain, and the corrected signal may be configured to resemble the initial signal sent from the node. Thus, at the output of each FDX amplifier, the output signal may be substantially equal to the signal initially sent from the node, such that every FDX amplifier in the cascade receives a substantially similar signal.

At step 2406, the corrected signal may be sent to the next FDX amplifier (or node) in the line. The corrected signal may be substantially similar to an initial signal sent by the node. Each one of the FDX amplifiers may be configured to measure the signal profile at a plurality of locations within the amplifier to determine the effects of attenuation and distortion of the signal. The FDX amplifiers may periodically re-measure the signal to determine if adjustments to the corrections may improve the resulting signal output from the FDX amplifiers.

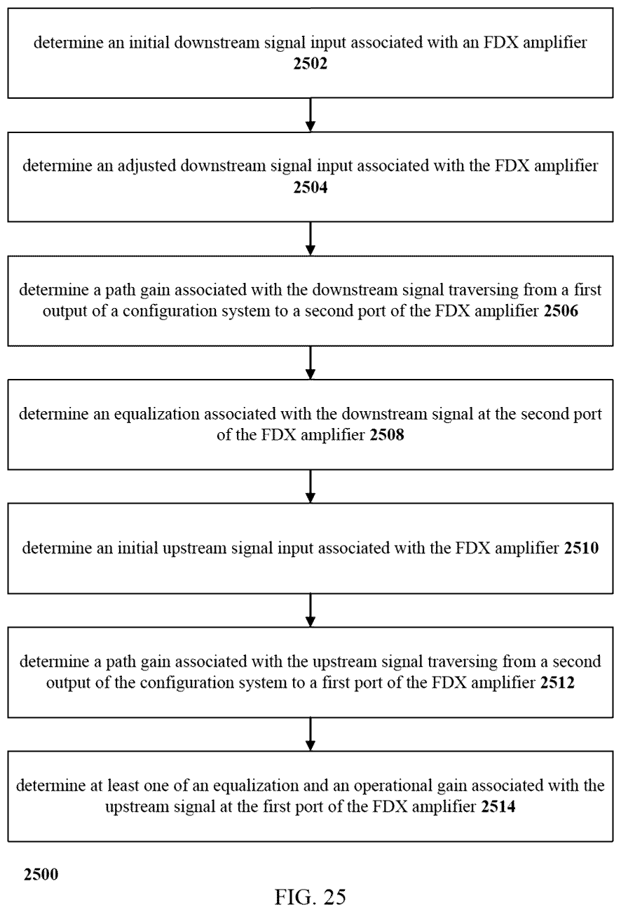

FIG. 25 shows an example method. The method described in FIG. 25 may be used by a system, for example by an FDX amplifier configuration system, to configure an amplifier to operate in a full duplex DOCSIS scheme. For example, the system of FIG. 25 may be implemented by the systems described in any one of FIG. 1, 2, 5, 13, 21, or 22. For example, the method may take place by a system on chip embedded in the FDX amplifier.

At step 2502, the system may determine an initial downstream signal input associated with an FDX amplifier. For example, the initial downstream signal input may be associated with a test signal. For example, the initial downstream signal may be a test signal injected into the system. For example, the initial downstream signal may be a test signal generated by the FDX amplifier, or the initial downstream signal may be a test signal injected at the FDX amplifier or at a different amplifier. The FDX amplifier may be associated with an embedded cable modem. The embedded cable modem may be activated. The embedded cable modem may provide access for the FDX amplifier to communicate with a central server or monitoring station. For example, the FDX amplifier may communicate, via the embedded cable modem, with a central amplifier system. The FDX amplifier may be calibrated. For example, one or more calibration files associated with the FDX amplifier may be provided. For example, the one or more calibration files may be provided by a manufacturer of the FDX amplifier. The FDX amplifier may be calibrated using the one or more calibration files.

At step 2504, the system may determine an adjusted downstream signal input associated with the FDX amplifier. The FDX amplifier may determine a path loss associated with the initial downstream signal traversing from a first port of the FDX amplifier to a first input of the configuration system. For example, the first port of the FDX amplifier may be a “north” port of the FDX amplifier. The north port may be an input port of the FDX amplifier for any received downstream signals. The north port may be an output port of the FDX amplifier for any sent upstream signals. The first input of the configuration system may be an input of a system on a chip configuration system in the FDX amplifier. For example, the first input of the configuration system may comprise an analog front end. For example, the first input of the configuration system may comprise an analog to digital converter. The amplifier may communicate using analog signals. The configuration system may communicate using digital signals.

The configuration system may determine a span loss of the initial downstream signal traversing from an output port of a different amplifier to the first port of the FDX amplifier. For example, the span loss may be associated with a span loss of the downstream signal traversing between the end of a previous amplifier and entering the FDX amplifier. The configuration system may determine, based on the path loss and the span loss, an adjusted downstream signal associated with the FDX amplifier.

At step 2506, the system may determine a path gain associated with the downstream signal traversing from a first output of a configuration system to a second port of the FDX amplifier. For example, the first output of the configuration system may be associated with a digital to analog converter of the system on a chip configuration system. The second port of the FDX amplifier may be a “south” port of the FDX amplifier. The south port may be an output port of the FDX amplifier for any sent downstream signals. The south port may be an input port of the FDX amplifier for any received upstream signals.

At step 2508, the system may determine an equalization associated with the downstream signal at the second port of the FDX amplifier. For example, as the downstream signal traverses the amplifier the signal may become distorted. For example, the power spectral density of the downstream signal may become distorted. The downstream signal may have a known, desired frequency and power, but the downstream signal may become distorted. The equalization may cause the distorted downstream signal frequencies to be corrected.

At step 2510, the system may determine an initial upstream signal input associated with the FDX amplifier. For example, the initial upstream signal input may be associated with a test signal. For example, the initial upstream signal may be a test signal injected into the system. For example, the initial upstream signal may be a test signal generated by the FDX amplifier, or the initial upstream signal may be a test signal injected at the FDX amplifier or at a different amplifier. The FDX amplifier may be associated with an embedded cable modem. The embedded cable modem may be activated. The embedded cable modem may provide access for the FDX amplifier to communicate with a central server or monitoring station. For example, the FDX amplifier may communicate, via the embedded cable modem, with a central amplifier system. The FDX amplifier may be calibrated. For example, one or more calibration files associated with the FDX amplifier may be provided. For example, the one or more calibration files may be provided by a manufacturer of the FDX amplifier. The FDX amplifier may be calibrated using the one or more calibration files.

At step 2512, the system may determine a path gain associated with the upstream signal traversing from a second output of the configuration system to a first port of the FDX amplifier. For example, the second output of the configuration system may be associated with a digital to analog converter of the system on a chip configuration system. The first port of the FDX amplifier may be the north port of the FDX amplifier. The north port may be an output port of the FDX amplifier for any sent upstream signals. The north port may be an input port of the FDX amplifier for any received downstream signals.

At step 2514, the system may determine at least one of an equalization and an operational gain associated with the upstream signal at the first port of the FDX amplifier. For example, the system may determine an equalization associated with the upstream signal at the first port of the FDX amplifier. For example, as the upstream signal traverses the FDX amplifier the signal may become distorted. For example, the power spectral density of the upstream signal may become distorted. The upstream signal may have a known, desired frequency and power, but the upstream signal may become distorted. The equalization may cause the distorted upstream signal frequencies to be corrected. The operational gain associated with the upstream signal may cause the distorted upstream signal power to be corrected based on the known, desired power of the upstream signal transmitted from the FDX amplifier.

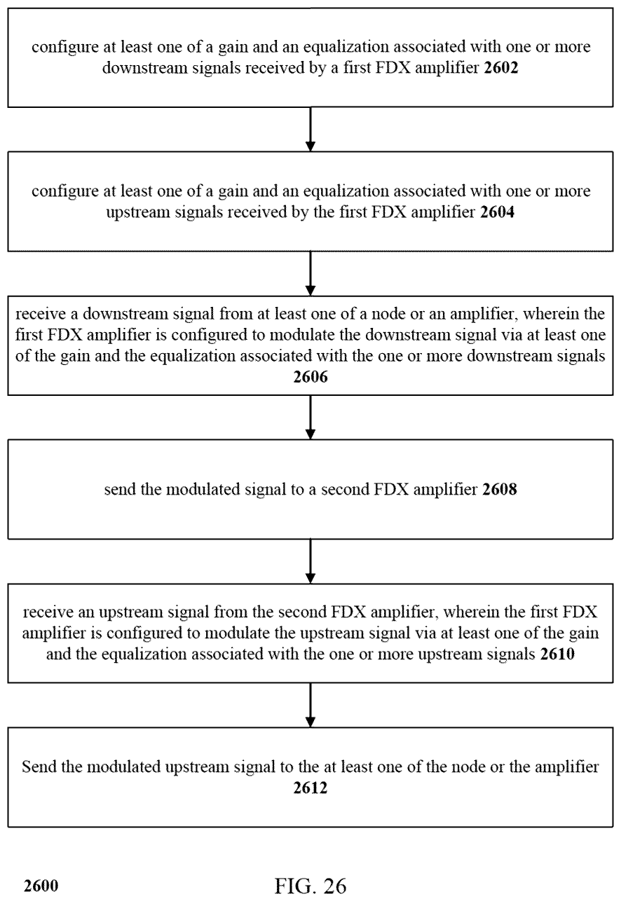

FIG. 26 shows an example method. The method described in FIG. 26 may be used by a system, for example by an FDX amplifier configuration system, to configure an amplifier to operate in a full duplex DOCSIS scheme within a cascade of a plurality of FDX amplifiers. For example, the system of FIG. 26 may be implemented by the systems described in any one of FIG. 1, 2, 5, 13, 21 or 22. For example, the method may take place by a system on a chip embedded in an FDX amplifier. FIG. 26 describes a plurality of amplifiers and may describe a plurality of FDX amplifiers. The FDX amplifier may be in communication with a cascade of one or more additional amplifiers, and the FDX amplifier may amplify a downstream or an upstream signal before passing the downstream or the upstream signal to a next amplifier in the cascade. In between two amplifiers there may be any number of taps or other computing devices that may be in communication with the two amplifiers. For example, a downstream signal may leave the FDX amplifier, pass through one or more taps, and then enter the next amplifier in the cascade. The next amplifier may amplify the downstream signal to correct any distortion or damage caused by any one of the FDX amplifier, the one or more taps, or any other distortion or damage caused to the downstream signal. The same, but opposite, scenario is true for an upstream signal. For example, an upstream signal may leave the FDX amplifier, pass through one or more taps, and then enter the next amplifier in the cascade. The next amplifier may amplify the upstream signal to correct any distortion or damage caused by any one of the FDX amplifier, the one or more taps, or any other distortion or damage caused to the upstream signal.

In step 2602, the system may configure at least one of a gain and an equalization associated with one or more downstream signals received by a first FDX amplifier. For example, the FDX amplifier may be calibrated with a test signal, for example an initial downstream signal with known properties, or with one or more calibration files associated with the FDX amplifier. The FDX amplifier may be configured to determine a loss associated with the downstream signal as the downstream signal traverses from one amplifier to the FDX amplifier, and as the downstream signal traverses through the FDX amplifier from an input port of the FDX amplifier to an output port of the FDX amplifier. The FDX amplifier may determine at least one of a gain and an equalization that may reverse the loss associated with the downstream signal to restore the downstream signal to a known, desired frequency and power.

In step 2604, the system may configure at least one of a gain and an equalization associated with one or more upstream signals received by the first FDX amplifier. For example, the FDX amplifier may be calibrated with a test signal, for example an initial upstream signal with known properties, or with one or more calibration files associated with the FDX amplifier. The FDX amplifier may be configured to determine a loss associated with the upstream signal as the upstream signal traverses from one amplifier to the FDX amplifier, and as the upstream signal traverses through the FDX amplifier from an input port of the FDX amplifier to an output port of the FDX amplifier. The FDX amplifier may determine at least one of a gain and an equalization that may reverse the loss associated with the upstream signal to restore the upstream signal to a known, desired frequency and power. The FDX amplifier may be configured to determine an echo associated with a reflected portion of a downstream signal that may cause noise associated with the upstream signal. The FDX amplifier may be configured to determine, based on the at least one of the gain and the equalization associated with the one or more downstream signals determined in step 2602, to reduce the noise associated with the downstream signal echo. An echo canceler may reduce the echo of the downstream signal in the upstream signal.

At step 2606, the system may receive a downstream signal from at least one of a node or an amplifier, wherein the first FDX amplifier is configured to modulate the downstream signal via at least one of the gain and the equalization associated with the one or more downstream signals. For example, a node may generate and send a downstream signal to a cascade of amplifiers and a plurality of taps. The node may be a headend. A first amplifier in the system may receive the downstream signal from the node. The first amplifier may send the downstream signal to the FDX amplifier. The FDX amplifier may send the downstream signal to another amplifier further along in the cascade. However, the downstream signal may degrade as the downstream signal traverses the path from the node through the cascade of amplifiers and taps. For example, the frequency and the power of the downstream signal may be degraded. The FDX amplifier may be configured to determine at least one of the gain and the equalization associated with the downstream signal, and the FDX amplifier may modulate the downstream signal to reduce the distortion caused to the downstream signal. For example, the FDX amplifier may be configured to alter the downstream signal to substantially return the downstream signal to the form the downstream signal was in when sent from the node initially. Each amplifier in the cascade may be configured to modulate the downstream signal to substantially return the downstream signal to the form the downstream signal was in when sent from the node initially.

At step 2608, the FDX amplifier may send the modulated downstream signal to another amplifier in the cascade. For example, the system may modulate the downstream signal by adding at least one of a gain or an equalization to the downstream signal, and the FDX amplifier may send the modulated signal to another amplifier, for example a second FDX amplifier.

At step 2610, the FDX amplifier may receive an upstream signal from the second FDX amplifier, wherein the FDX amplifier is configured to modulate the upstream signal via at least one of the gain and the equalization associated with the one or more upstream signals. For example, an FDX amplifier at the end of a cascade of amplifiers may send an upstream signal to the cascade of amplifiers and a plurality of taps. The FDX amplifier may receive the upstream signal from the second FDX amplifier, and the FDX amplifier may send the upstream signal to another amplifier further along in the cascade. However, the upstream signal may degrade as the upstream signal traverses the path from the second FDX amplifier through the cascade of amplifiers and taps. For example, the frequency and the power of the upstream signal may be degraded. The FDX amplifier may be configured to determine at least one of the gain and the equalization associated with the upstream signal, and the FDX amplifier may modulate the upstream signal to reduce the distortion caused to the upstream signal. For example, the FDX amplifier may be configured to alter the upstream signal to substantially return the upstream signal to the form the upstream signal was in when sent from the second FDX amplifier initially. Each amplifier in the cascade may be configured to modulate the upstream signal to substantially return the upstream signal to the form the upstream signal was in when sent from the second FDX amplifier initially.

At step 2612, the FDX amplifier may send the modulated upstream signal to the at least one of the node or an additional amplifier, for example an additional FDX amplifier. For example, the FDX amplifier may modulate the upstream signal by adding at least one of a gain or an equalization to the upstream signal, and the FDX amplifier may send the modulated upstream signal to another amplifier, for example an additional FDX amplifier closer to the node. The modulated upstream signal may be further modulated at one or more additional FDX amplifiers in the cascade, and the further modulated upstream signal may be sent to the node.

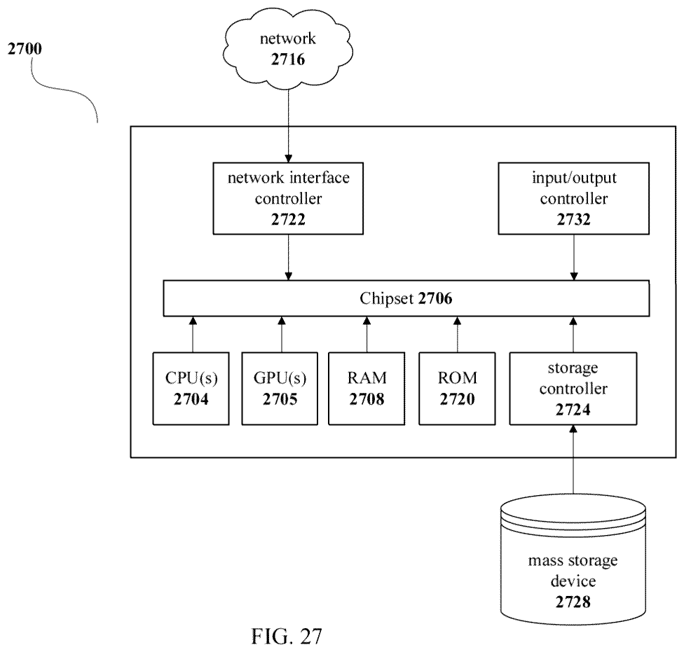

FIG. 27 shows an example computing device 2700. The example computing device 2700 may be used to implement any of the various devices or entities shown in FIG. 2 or FIG. 21, including, for example, the amplifier 200 or the amplifier 2100, or a database associated with the system, for example a central server or a central server database associated with at least one of amplifier 200 and amplifier 2100. That is, the computing device 2700 shown in FIG. 27 may comprise any smartphone, server computer, workstation, access point, router, gateway, tablet computer, laptop computer, notebook computer, desktop computer, personal computer, network appliance, PDA, e-reader, user equipment (UE), mobile station, fixed or mobile subscriber unit, pager, wireless sensor, consumer electronics, or other computing device, and may be utilized to execute any aspects of the methods and apparatus described herein, such as to implement any of the apparatus of FIG. 2 or 21, or any of the methods described in relation to FIGS. 24-26.

The computing device 2700 may comprise a baseboard, or “motherboard,” which is a printed circuit board to which a multitude of components or devices may be connected by way of a system bus or other electrical communication paths. One or more central processing units (CPUs or “processors”) 2704 may operate in conjunction with a chipset 2706. The CPU(s) 2704 may be standard programmable processors that perform arithmetic and logical operations necessary for the operation of the computing device 2700.

The CPU(s) 2704 may perform the necessary operations by transitioning from one discrete physical state to the next through the manipulation of switching elements that differentiate between and change these states. Switching elements may generally comprise electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, or the like.

The CPU(s) 2704 may be augmented with or replaced by other processing units, such as GPU(s) 2705. The GPU(s) 2705 may comprise processing units specialized for but not necessarily limited to highly parallel computations, such as graphics and other visualization-related processing.

A chipset 2706 may provide an interface between the CPU(s) 2704 and the remainder of the components and devices on the baseboard. The chipset 2706 may provide an interface to a random-access memory (RAM) 2708 used as the main memory in the computing device 2700. The chipset 2706 may provide an interface to a computer-readable storage medium, such as a read-only memory (ROM) 2720 or non-volatile RAM (NVRAM) (not shown), for storing basic routines that may help to start up the computing device 2700 and to transfer information between the various components and devices. ROM 2720 or NVRAM may also store other software components necessary for the operation of the computing device 2700 in accordance with the aspects described herein.

The computing device 2700 may operate in a networked environment using logical connections to remote computing nodes and computer systems of the system 100. The chipset 2706 may comprise functionality for providing network connectivity through a network interface controller (NIC) 2722. A NIC 2722 may be capable of connecting the computing device 2700 to other computing nodes over the system. It should be appreciated that multiple NICs 2722 may be present in the computing device 2700, connecting the computing device to other types of networks and remote computer systems. The NIC 2722 may be configured to implement a wired local area network technology, such as IEEE 802.3 (“Ethernet”) or the like. The NIC 2722 may also comprise any suitable wireless network interface controller capable of wirelessly connecting and communicating with other devices or computing nodes on the system 100. For example, the NIC 2722 may operate in accordance with any of a variety of wireless communication protocols, including for example, the IEEE 802.11 (“Wi-Fi”) protocol, the IEEE 802.16 or 802.20 (“WiMAX”) protocols, the IEEE 802.15.4a (“Zigbee”) protocol, the 802.15.3c (“UWB”) protocol, or the like.

The computing device 2700 may be connected to a mass storage device 2728 that provides non-volatile storage (i.e., memory) for the computer. The mass storage device 2728 may store system programs, application programs, other program modules, and data, which have been described in greater detail herein. The mass storage device 2728 may be connected to the computing device 2700 through a storage controller 2724 connected to the chipset 2706. The mass storage device 2728 may consist of one or more physical storage units. A storage controller 2724 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 2700 may store data on a mass storage device 2728 by transforming the physical state of the physical storage units to reflect the information being stored. The specific transformation of a physical state may depend on various factors and on different implementations of this description. Examples of such factors may comprise, but are not limited to, the technology used to implement the physical storage units and whether the mass storage device 2728 is characterized as primary or secondary storage or the like.

For example, the computing device 2700 may store information to the mass storage device 2728 by issuing instructions through a storage controller 2724 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 2700 may read information from the mass storage device 2728 by detecting the physical states or characteristics of one or more particular locations within the physical storage units.

In addition to the mass storage device 2728 described herein, the computing device 2700 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 2700.

By way of example and not limitation, computer-readable storage media may comprise volatile and non-volatile, non-transitory computer-readable storage media, and removable and non-removable media implemented in any method or technology. However, as used herein, the term computer-readable storage media does not encompass transitory computer-readable storage media, such as signals. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other non-transitory medium that may be used to store the desired information in a non-transitory fashion.

A mass storage device, such as the mass storage device 2728 depicted in FIG. 27, may store an operating system utilized to control the operation of the computing device 2700. The operating system may comprise a version of the LINUX operating system. The operating system may comprise a version of the WINDOWS SERVER operating system from the MICROSOFT Corporation. According to additional aspects, the operating system may comprise a version of the UNIX operating system. Various mobile phone operating systems, such as IOS and ANDROID, may also be utilized. It should be appreciated that other operating systems may also be utilized. The mass storage device 2728 may store other system or application programs and data utilized by the computing device 2700.

The mass storage device 2728 or other computer-readable storage media may also be encoded with computer-executable instructions, which, when loaded into the computing device 2700, transforms the computing device from a general-purpose computing system into a special-purpose computer capable of implementing the aspects described herein. These computer-executable instructions transform the computing device 2700 by specifying how the CPU(s) 2704 transition between states, as described herein. The computing device 2700 may have access to computer-readable storage media storing computer-executable instructions, which, when executed by the computing device 2700, may perform the methods described in relation to FIGS. 24-26.

A computing device, such as the computing device 2700 depicted in FIG. 27, may also comprise an input/output controller 2732 for receiving and processing input from a number of input devices, such as a keyboard, a mouse, a touchpad, a touch screen, an electronic stylus, or other type of input device. Similarly, an input/output controller 2732 may provide output to a display, such as a computer monitor, a flat-panel display, a digital projector, a printer, a plotter, or other type of output device. It will be appreciated that the computing device 2700 may not comprise all of the components shown in FIG. 27, may comprise other components that are not explicitly shown in FIG. 27, or may utilize an architecture completely different than that shown in FIG. 27.

As described herein, a computing device may be a physical computing device, such as the computing device 2700 of FIG. 27. A computing device may also comprise a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems described herein are not limited to specific methods, specific components, or to particular implementations. It is also to be understood that the terminology used herein is not intended to be limiting.

As used in the specification and the appended claims, the singular forms “a,” “an,” and “the” comprise plural referents unless the context clearly dictates otherwise. Ranges may be expressed herein as from “about” one particular value, and/or to “about” another particular value. When such a range is expressed, another example may comprise from the one particular value and/or to the other particular value. It will be further understood that the endpoints of each of the ranges are significant both in relation to the other endpoint, and independently of the other endpoint.

“Optional” or “optionally” means that the subsequently described event or circumstance may or may not occur, and that the description comprises instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers, or steps. “Exemplary” means “an example of.” “Such as” is not used in a restrictive sense, but for explanatory purposes.

Components and devices are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any combination of the described methods.

As will be appreciated by one skilled in the art, the methods and systems may take the form of entirely hardware, entirely software, or a combination of software and hardware aspects. Furthermore, the methods and systems may take the form of a computer program product on a computer-readable storage medium having computer-readable instructions (e.g., computer software or program code) embodied in the storage medium. More particularly, the present methods and systems may take the form of web-implemented computer software. Any suitable computer-readable storage medium may be utilized including hard disks, CD-ROMs, optical storage devices, or magnetic storage devices.

The methods and systems are described above with reference to block diagrams and flowcharts of methods, systems, apparatuses, and computer program products. It will be understood that each block of the block diagrams and flowcharts, and combinations of blocks in the block diagrams and flowcharts, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described herein may be used independently of one another or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added or removed. The example systems and components described herein may be configured differently than described. For example, elements may be added to, removed from, or rearranged.

It will also be appreciated that various items are shown as being stored in memory or on storage while being used, and that these items or portions thereof may be transferred between memory and other storage devices for purposes of memory management and data integrity. Alternatively, some or all of the software modules and/or systems may execute in memory on another device and communicate with the shown computing systems via inter-computer communication. Furthermore, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms. Accordingly, the present invention may be practiced with other computer system configurations.

While the methods and systems have been described in connection with specific examples, it is not intended that the scope be limited to the specific examples set forth.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including matters of logic with respect to arrangement of steps or operational flow and the plain meaning derived from grammatical organization or punctuation.

It will be apparent to those skilled in the art that various modifications and variations may be made without departing from the scope or spirit of the present disclosure. Alternatives will be apparent to those skilled in the art from consideration of the specification and practices described herein. It is intended that the specification and example figures be considered as exemplary only, with a true scope and spirit being indicated by the following claims.

What is claimed is:

1. A method comprising:
configuring, via a configuration system associated with a first full duplex DOCSIS (FDX) amplifier, at least one of a gain and an equalization associated with one or more downstream signals received by the first FDX amplifier;
configuring, via the configuration system associated with the first FDX amplifier, at least one of a gain and an equalization associated with one or more upstream signals received by the first FDX amplifier;
receiving, from at least one of a node or an upstream amplifier, a downstream signal, wherein the first FDX amplifier is configured to modulate the downstream signal via at least one of the gain and the equalization associated with the one or more downstream signals;
sending, to a second FDX amplifier downstream of the first FDX amplifier, the modulated downstream signal;
receiving, from the second FDX amplifier, an upstream signal, wherein the first FDX amplifier is configured to modulate the upstream signal via at least one of the gain and the equalization associated with the one or more upstream signals; and
sending, to the at least one of the node or the upstream amplifier, the modulated upstream signal.

2. The method of claim 1, wherein modulating the upstream signal via the at least one of the gain and the equalization further comprises reducing, via an echo canceler, an echo of the downstream signal.

3. The method of claim 2, wherein the echo of the downstream signal comprises a reflection of the downstream signal in the upstream signal.

4. The method of claim 1, wherein the configuration system comprises a system on chip component of the first FDX amplifier.

5. The method of claim 1, wherein the configuration system digitizes analog signals from the FDX amplifier via an analog to digital converter, and wherein the configuration system outputs, to the FDX amplifier, analog signals via a digital to analog converter.

6. The method of claim 1, wherein the downstream signal and the upstream signal occupy at least partially overlapping portions of a frequency band.

7. The method of claim 6, wherein the downstream signal occupies at least a portion of the frequency band from substantially 100 megahertz to substantially 1.2 gigahertz, and wherein the upstream signal occupies at least a portion of the frequency band from substantially 8 megahertz to 700 megahertz.

8. A method comprising:
determining an initial downstream signal input associated with a full duplex DOCSIS (FDX) amplifier, wherein a downstream signal traverses a configuration system associated with the FDX amplifier;
determining, based on a path loss associated with the downstream signal traversing from a first port of the FDX amplifier to a first input of the configuration system, and further based on a span loss of the downstream signal traversing from an output port of a different amplifier to the first port of the FDX amplifier, an adjusted downstream signal input associated with the FDX amplifier;
determining a path gain associated with the downstream signal traversing from a first output of the configuration system to a second port of the FDX amplifier;
determining an equalization associated with the downstream signal at the second port of the FDX amplifier;
determining an initial upstream signal input associated with the FDX amplifier, wherein an upstream signal traverses the configuration system associated with the FDX amplifier;
determining a path gain associated with the upstream signal traversing from a second output of the configuration system to the first port of the FDX amplifier;
determining at least one of an equalization and an operational gain associated with the upstream signal at the first port of the FDX amplifier; and
configuring, by the FDX amplifier one or more of a gain associated with the downstream signal, an equalization associated with the downstream signal, a gain associated with the upstream signal, or an equalization associated with the upstream signal.

9. The method of claim 8, wherein the first port of the FDX amplifier is associated with an input of the downstream signal and an output of the upstream signal, and wherein the second port of the FDX amplifier is associated with an output of the downstream signal and an input of the upstream signal.

10. The method of claim 8, wherein the configuration system comprises a system on chip component of the FDX amplifier.

11. The method of claim 8, wherein determining the equalization of the upstream signal comprises reducing, via an echo canceler, an echo of the downstream signal.

12. The method of claim 11, wherein the echo of the downstream signal comprises a reflection of the downstream signal in the upstream signal.

13. The method of claim 8, wherein the configuration system digitizes analog signals from the FDX amplifier via an analog to digital converter, and wherein the configuration system outputs, to the FDX amplifier, analog signals via a digital to analog converter.

14. The method of claim 8, wherein the downstream signal and the upstream signal occupy at least partially overlapping portions of a frequency band.

15. The method of claim 14, wherein the downstream signal occupies at least a portion of the frequency band from substantially 100 megahertz to substantially 1.2 gigahertz, and wherein the upstream signal occupies at least a portion of the frequency band from substantially 8 megahertz to 700 megahertz.

16. A method comprising:
configuring, via a configuration system associated with a first full duplex DOCSIS (FDX) amplifier, at least one of an equalization or a gain associated with correcting at least one of a distortion or attenuation of a received signal, wherein the received signal comprises at least one of a downstream signal or an upstream signal;
correcting, via the configured at least one equalization or gain, the received signal; and
causing sending the corrected received signal, wherein downstream signals are sent to a downstream FDX amplifier, and wherein upstream signals are sent to at least one of an upstream FDX amplifier or an upstream FDX node.

17. The method of claim 16, wherein the downstream FDX amplifier is configured to apply a further correction to the downstream signal based on at least one of a distortion or an attenuation associated with the sending the signal from the first FDX amplifier to the downstream FDX amplifier.

18. The method of claim 16, wherein the configuration system comprises a system on chip component of the first FDX amplifier, and wherein the configuration system is further configured to:
convert, at an input of the system on chip component, analog signals to digital signals via an analog to digital converter; and
convert, at an output of the system on chip component, the digital signals to analog signals via a digital to analog converter.

19. The method of claim 16, wherein the correcting the received upstream signal comprises reducing, via an echo canceler, an echo of the received downstream signal.

20. The method of claim 16, wherein the downstream signal and the upstream signal occupy at least partially overlapping portions of a frequency band.

21. The method of claim 20, wherein the downstream signal occupies at least a portion of the frequency band from substantially 100 megahertz to substantially 1.2 gigahertz, and wherein the upstream signal occupies at least a portion of the frequency band from substantially 8 megahertz to 700 megahertz.
